(19) United States
(12) Patent Application Publication
(10) Pub. No.: US 2014/0234725 A1
(43) Pub. Date: Aug. 21, 2014

(54) METHOD FOR PRODUCING NONAQUEOUS-ELECTROLYTE BATTERY AND NONAQUEOUS-ELECTROLYTE BATTERY

(71) Applicant: SUMITOMO ELECTRIC INDUSTRIES, LTD., Osaka-shi, Osaka (JP)

(72) Inventors: Mitsuyasu Ogawa, Itami-shi (JP); Kazuhiro Goto, Itami-shi (JP); Kentaro Yoshida, Itami-shi (JP); Takashi Uemura, Itami-shi (JP); Ryoko Kanda, Itami-shi (JP); Keizo Harada, Itami-shi (JP)

(73) Assignee: SUMITOMO ELECTRIC INDUSTRIES, LTD., Osaka-shi (JP)

(21) Appl. No.: 14/346,003

(22) PCT Filed: Feb. 14, 2013
(86) PCT No.: PCT/JP2013/053478

§ 371 Date: Mar. 20, 2014

(30) Foreign Application Priority Data
Apr. 27, 2012 (JP) 2012-103784

(51) Int. Cl. H01M 10/058; H01M 10/052; H01M 10/0562

(52) U.S. Cl. CPC H01M 10/058; H01M 10/0562; H01M 10/052
USPC 429/304; 29/623.1

(57) ABSTRACT

Provided is a method for producing a nonaqueous-electrolyte battery. A positive-electrode body 1 is prepared that includes a positive-electrode active-material layer 12 including a powder-molded body, and a positive-electrode-side solid-electrolyte layer 13 that is amorphous and formed by a vapor-phase process. A negative-electrode body 2 is prepared that includes a negative-electrode active-material layer 22 including a powder-molded body, and a negative-electrode-side solid-electrolyte layer 23 that is amorphous and formed by a vapor-phase process. The positive-electrode body 1 and the negative-electrode body 2 are bonded together by subjecting the electrode bodies 1 and 2 being arranged such that the solid-electrolyte layers 13 and 23 are in contact with each other, to a heat treatment under application of a pressure to crystallize the solid-electrolyte layers 13 and 23. The positive-electrode active-material layer 12 is obtained by press-molding a positive-electrode active-material powder formed of boron-doped LiNi_{α}Co_{β}Al_{γ}O₂ or LiNi_{α}Mn_{β}Co_{γ}O₂ and a sulfide-solid-electrolyte powder.

### TECHNICAL FIELD

The present invention relates to a method for producing a nonaqueous-electrolyte battery in which a positive-electrode body including a positive-electrode active-material layer and a positive-electrode-side solid-electrolyte layer and a negative-electrode body including a negative-electrode active-material layer and a negative-electrode-side solid-electrolyte layer are separately produced and the electrode bodies are laminated in a subsequent step; and a nonaqueous-electrolyte battery obtained by the production method.

### BACKGROUND ART

Nonaqueous-electrolyte batteries including a positive-electrode layer, a negative-electrode layer, and an electrolyte layer disposed between the electrode layers are used as power supplies that are intended to be repeatedly charged and discharged. The electrode layers of such a battery include a collector having a current-collecting function and an active-material layer containing an active material. Among such nonaqueous-electrolyte batteries, in particular, nonaqueous-electrolyte batteries that are charged and discharged through migration of Li ions between the positive- and negative-electrode layers, have a high discharge capacity in spite of the small size.

An example of techniques for producing such a nonaqueous-electrolyte battery is described in Patent Literature 1. In this Patent Literature 1, a nonaqueous-electrolyte battery is produced in the following manner. A positive-electrode body and a negative-electrode body are separately produced, the positive-electrode body having a positive-electrode active-material layer that is a powder-molded body on a positive-electrode collector, the negative-electrode body having a negative-electrode active-material layer that is a powder-molded body on a negative-electrode collector. Each of these electrode bodies has a solid-electrolyte layer. The positive-electrode body and the negative-electrode body are laminated to produce the nonaqueous-electrolyte battery. At the time of the lamination, in the technique in Patent Literature 1, the solid-electrolyte layers of the electrode bodies are press-bonded together under a high pressure of more than 950 MPa.

### CITATION LIST

### Patent Literature

PTL 1: Japanese Unexamined Patent Application Publication No. 2008-103289

### SUMMARY OF INVENTION

### Technical Problem

However, the nonaqueous-electrolyte battery in PTL 1 has the following problems.

First, since the two electrode bodies are press-bonded together under a high pressure, for example, the electrode bodies may be cracked. In particular, active-material layers that are powder-molded bodies are easily cracked. Cracking of such an active-material layer may result in considerable degradation of the performance of the nonaqueous-electrolyte battery.

Second, since the solid-electrolyte layer of the nonaqueous-electrolyte battery in PTL 1 is formed by press-bonding together a positive-electrode-side solid-electrolyte layer and a negative-electrode-side solid-electrolyte layer, a bonding interface is formed between the positive-electrode-side solid-electrolyte layer and the negative-electrode-side solid-electrolyte layer. The bonding interface tends to have a high resistance. Accordingly, the discharge capacity or discharge output of the nonaqueous-electrolyte battery may be much lower than the theoretical value.

The present invention has been made under the above-described circumstances. An object of the present invention is to provide a method for producing a nonaqueous-electrolyte battery by which, in spite of bonding of two electrode bodies that are separately produced, a nonaqueous-electrolyte battery in which a high-resistance layer is not formed at the bonding interface between the electrode bodies can be produced; and a nonaqueous-electrolyte battery obtained by the production method.

### Solution to Problem

The present invention provides three embodiments of a method for producing a nonaqueous-electrolyte battery. These three embodiments will be sequentially described. Note that, each “thickness” in the Description denotes the average of thicknesses measured at five or more different portions. Regarding “thickness”, the measurement can be performed by, for example, observation of a section with a scanning electron microscope.

(1) A method for producing a nonaqueous-electrolyte battery according to the present invention is a method for producing a nonaqueous-electrolyte battery including a positive-electrode active-material layer, a negative-electrode active-material layer, and a sulfide-solid-electrolyte layer (hereafter, a SE layer) disposed between these active-material layers, the method including the following steps.
A step of preparing a positive-electrode body including a positive-electrode active-material layer including a powder-molded body, and a positive-electrode-side solid-electrolyte layer (hereafter, a PSE layer) that is amorphous and formed on the positive-electrode active-material layer by a vapor-phase process.
A step of preparing a negative-electrode body including a negative-electrode active-material layer including a powder-molded body, and a negative-electrode-side solid-electrolyte layer (hereafter, a NSE layer) that is amorphous and formed on the negative-electrode active-material layer by a vapor-phase process.
A step of bonding together the positive-electrode body and the negative-electrode body by subjecting the electrode bodies being arranged such that the solid-electrolyte layers of the electrode bodies are in contact with each other, to a heat treatment under application of a pressure to crystallize the PSE layer and the NSE layer.

Here, the positive-electrode active-material layer is obtained by [1] or [2] below:

[1] obtained by press-molding a positive-electrode active-material powder formed of boron-doped LiNi_{α}Co_{β}Al_{γ}O₂ (α=0.80 to 0.81, β=0.15, γ=0.04 to 0.05; hereafter, referred to as NCA) and a sulfide-solid-electrolyte powder, or

[2] obtained by press-molding a positive-electrode active-material powder formed of LiNi_{α}Mn_{β}Co_{γ}O₂ (α=0.1 to 0.8, β=0.1 to 0.8, γ=0.1 to 0.8; hereafter, referred to as NMC) and a sulfide-solid-electrolyte powder.

Note that, needless to say, such a powder is a mass of particles.

In a method for producing a nonaqueous-electrolyte battery according to the present invention, the PSE layer and the NSE layer are bonded together by utilizing atomic interdiffusion during change from amorphous to crystalline. Accordingly, a bonding interface having a high resistance is substantially not formed between the PSE layer and the NSE layer.

In addition, in a method for producing a nonaqueous-electrolyte battery according to the present invention, since the PSE layer and the NSE layer are bonded together by utilizing crystallization caused by a heat treatment, high-pressure compression of the positive-electrode body and the negative-electrode body is not necessary during bonding of the PSE layer and the NSE layer. Thus, defects such as cracking are less likely to occur in the constituent components of the electrode bodies. In particular, in a production method according to the present invention, the active-material layers each include a powder-molded body, which relatively easily cracks. Accordingly, the feature that high-pressure compression of the PSE layer and the NSE layer is not necessary is a huge advantage in the production of a nonaqueous-electrolyte battery. Note that the active-material layers each include a powder-molded body because thick active-material layers can be easily formed, compared with vapor-phase processes; and, as a result, a nonaqueous-electrolyte battery having a high discharge capacity can be produced.

In addition, a method for producing a nonaqueous-electrolyte battery according to the present invention allows production of a nonaqueous-electrolyte battery having excellent cycle characteristics, that is, a nonaqueous-electrolyte battery in which the discharge capacity is less likely to decrease even with repeated charge and discharge. This is because, in the case of using NCA as a positive-electrode active material, NCA is excellent as a positive-electrode active material and boron added by doping to NCA suppresses a decrease in the discharge capacity. The details of the mechanism by which a decrease in the discharge capacity can be suppressed are not known. However, boron probably stabilizes the crystalline structure of NCA or bonding between NCA particles. Alternatively, boron may segregate on the surfaces of NCA particles and function as protective layers to suppress deterioration of NCA particles that is caused by a reaction with the surrounding sulfide-solid-electrolyte particles. On the other hand, in the case of using NMC as a positive-electrode active material, NMC undergoes a small change in volume during charge and discharge of the battery and the contact between NMC particles and sulfide-solid-electrolyte particles in the positive-electrode active-material layer is probably sufficiently maintained, so that a nonaqueous-electrolyte battery having excellent cycle characteristics is provided. Note that NMC tends to react with organic electrolytic solutions and hence organic-electrolytic-solution batteries employing NMC usually have poor cycle characteristics. Thus, the fact that a nonaqueous-electrolyte battery employing NMC according to the present invention has excellent cycle characteristics is an unexpected result for those skilled in the art.

(2) A method for producing a nonaqueous-electrolyte battery according to the present invention is a method for producing a nonaqueous-electrolyte battery including a positive-electrode active-material layer, a negative-electrode active-material layer, and a SE layer disposed between these active-material layers, the method including the following steps.
A step of preparing a positive-electrode body including a positive-electrode active-material layer including a powder-molded body, and a PSE layer that is amorphous, has a thickness of 2 μm or less, and is formed on the positive-electrode active-material layer by a vapor-phase process.
A step of preparing a negative-electrode body including a negative-electrode active-material layer including a powder-molded body.
A step of bonding together the positive-electrode body and the negative-electrode body by subjecting the electrode bodies being arranged such that the PSE layer and the negative-electrode active-material layer are in contact with each other, to a heat treatment under application of a pressure to crystallize the PSE layer.

Here, the positive-electrode active-material layer is obtained by press-molding a positive-electrode active-material powder formed of boron-doped NCA and a sulfide-solid-electrolyte powder, or is obtained by press-molding a positive-electrode active-material powder formed of NMC and a sulfide-solid-electrolyte powder.

The inventors of the present invention performed studies and, as a result, have found the following: when an amorphous PSE layer is a film having a small thickness of 2 μm or less, the PSE layer has high activity and hence the constituent material of the PSE layer tends to diffuse into the negative-electrode active-material layer during change of the PSE layer from amorphous to crystalline. Accordingly, when a nonaqueous-electrolyte battery is produced by the production method (2), a bonding interface having a high resistance is less likely to be formed between the positive-electrode body and the negative-electrode body in the battery. In contrast, when the PSE layer has a thickness of more than 2 μm, the PSE layer has low activity and the constituent material of the PSE layer is less likely to diffuse into the negative-electrode active-material layer. Accordingly, a bonding interface having a high resistance is formed between the positive-electrode body and the negative-electrode body.

In addition, in a nonaqueous-electrolyte battery obtained by the production method (2), the SE layer derived from the PSE layer has a very small thickness of 2 μm or less. Thus, the production method allows production of a nonaqueous-electrolyte battery having a smaller thickness than before.

In addition, regarding the nonaqueous-electrolyte battery obtained by the production method (2), a nonaqueous-electrolyte battery having excellent cycle characteristics can be produced. This is probably because, as in the production method (1), NCA (limited to boron-doped NCA) or NMC is used as the positive-electrode active material.

(3) A method for producing a nonaqueous-electrolyte battery according to the present invention is a method for producing a nonaqueous-electrolyte battery including a positive-electrode active-material layer, a negative-electrode active-material layer, and a SE layer disposed between these active-material layers, the method including the following steps.
A step of preparing a positive-electrode body including a positive-electrode active-material layer including a powder-molded body.
A step of preparing a negative-electrode body including a negative-electrode active-material layer including a powder-molded body, and a NSE layer that is amorphous, has a thickness of 2 μm or less, and is formed on the negative-electrode active-material layer by a vapor-phase process.
A step of bonding together the positive-electrode body and the negative-electrode body by subjecting the electrode bodies being arranged such that the positive-electrode active-material layer and the NSE layer are in contact with each other, to a heat treatment under application of a pressure to crystallize the NSE layer.

Here, the positive-electrode active-material layer is obtained by press-molding a positive-electrode active-material powder formed of boron-doped NCA and a sulfide-solid-electrolyte powder, or is obtained by press-molding a positive-electrode active-material powder formed of NMC and a sulfide-solid-electrolyte powder.

The inventors of the present invention performed studies and, as a result, have found the following: when an amorphous NSE layer is a film having a small thickness of 2 μm or less, the NSE layer has high activity and hence the constituent material of the NSE layer tends to diffuse into the positive-electrode active-material layer during change of the NSE layer from amorphous to crystalline. Accordingly, when a nonaqueous-electrolyte battery is produced by the production method (3), a bonding interface having a high resistance is less likely to be formed between the positive-electrode body and the negative-electrode body in the battery. In contrast, when the NSE layer has a thickness of more than 2 μm, the NSE layer has low activity and the constituent material of the NSE layer is less likely to diffuse into the negative-electrode active-material layer. Accordingly, a bonding interface having a high resistance is formed between the positive-electrode body and the negative-electrode body.

In addition, in a nonaqueous-electrolyte battery obtained by the production method (3), the SE layer derived from the NSE layer has a very small thickness of 2 μm or less. Thus, the production method allows production of a nonaqueous-electrolyte battery having a smaller thickness than before.

In addition, regarding the nonaqueous-electrolyte battery obtained by the production method (3), a nonaqueous-electrolyte battery having excellent cycle characteristics can be produced. This is probably because, as in the production method (1), NCA (limited to boron-doped NCA) or NMC is used as the positive-electrode active material.

Hereinafter, more preferred configurations of the above-described methods for producing a nonaqueous-electrolyte battery according to the present invention will be described.

(4) In a method for producing a nonaqueous-electrolyte battery according to an embodiment of the present invention, the battery employing boron-doped NCA as the positive-electrode active material, a doping content of the boron is preferably 0.1 to 10 atomic % with respect to 100 atomic % of NCA.

When the doping content of boron is 0.1 atomic % or more, the effect of doping NCA with boron can be sufficiently provided. When the doping content of boron is 10 atomic % or less, a corresponding decrease in the NCA content in the positive-electrode active-material layer can be suppressed.

(5) In a method for producing a nonaqueous-electrolyte battery according to an embodiment of the present invention, the heat treatment is preferably performed at 130° C. to 300° C. for 1 to 1200 minutes.

In the production method (1), heat-treatment conditions for bonding together the amorphous PSE layer and the amorphous NSE layer through crystallization can be appropriately selected in accordance with the type of the sulfide constituting the PSE layer and the NSE layer. In these years, regarding the sulfide, in particular, Li₂S—P₂S₅ has often been used. Li₂S—P₂S₅ can be sufficiently crystallized under the above-described heat-treatment conditions. Here, when the heat-treatment temperature is excessively low or the heat-treatment time is excessively short, the PSE layer and the NSE layer are not sufficiently crystallized and a bonding interface may be formed between the PSE layer and the NSE layer. On the other hand, when the heat-treatment temperature is excessively high or the heat-treatment time is excessively long, a crystal phase having a low Li-ion conductivity may be formed. By increasing the heat-treatment temperature in the above-described range, the time for crystallization (that is, the heat-treatment time) can be increasingly shortened. These descriptions also apply to the case for the production methods (2) and (3) in which a solid-electrolyte layer is formed in only one of the electrode bodies.

Note that the crystallization temperature of an amorphous Li₂S—P₂S₅ solid-electrolyte layer formed by a vapor-phase process is different from the crystallization temperature of a solid-electrolyte layer formed by press-molding an amorphous Li₂S—P₂S₅ powder. Specifically, the crystallization temperature of a Li₂S—P₂S₅ solid-electrolyte layer formed by a vapor-phase process is about 130° C., whereas the crystallization temperature of a Li₂S—P₂S₅ solid-electrolyte layer formed by a powder-molding process is about 240° C. Since the PSE layer and the NSE layer in a production method according to the present invention are formed by a vapor-phase process, the PSE layer and the NSE layer are crystallized at about 130° C.

(6) In a method for producing a nonaqueous-electrolyte battery according to an embodiment of the present invention, the pressure applied is preferably 160 MPa or less.

When the pressure applied is 160 MPa or less, more preferably 16 MPa or less, defects such as cracking in layers of the positive-electrode body and the negative-electrode body can be suppressed during bonding of these electrode bodies.

Hereinafter, nonaqueous-electrolyte batteries according to the present invention will be described.

(7) A nonaqueous-electrolyte battery according to the present invention is a nonaqueous-electrolyte battery including a positive-electrode active-material layer, a negative-electrode active-material layer, and a sulfide SE layer disposed between these active-material layers. This nonaqueous-electrolyte battery includes the following features.
The positive-electrode active-material layer and the negative-electrode active-material layer each include a powder-molded body.
The positive-electrode active-material layer contains a positive-electrode active-material powder formed of boron-doped NCA and a sulfide-solid-electrolyte powder, or contains a positive-electrode active-material powder formed of NMC and a sulfide-solid-electrolyte powder.
The SE layer is a crystalline integrated layer formed by bonding together a PSE layer disposed on a side of the positive-electrode active-material and a NSE layer disposed on a side of the negative-electrode active-material layer.
The SE layer has a resistance of 50 Ω·cm² or less (more preferably 20 Ω·cm² or less).

A nonaqueous-electrolyte battery having the above-described configuration (7) according to the present invention is a nonaqueous-electrolyte battery produced by the production method (1). In this battery, the SE layer has a low resistance, compared with batteries produced by existing methods. Accordingly, the battery exhibits excellent battery characteristics (discharge capacity and discharge output), compared with existing batteries. In addition, this nonaqueous-electrolyte battery according to the present invention employs NCA (limited to boron-doped NCA) or NMC as the positive-electrode active material and hence has excellent cycle characteristics, compared with existing nonaqueous-electrolyte batteries.

(8) A nonaqueous-electrolyte battery according to the present invention is a nonaqueous-electrolyte battery including a positive-electrode active-material layer, a negative-electrode active-material layer, and a sulfide SE layer disposed between these active-material layers. This nonaqueous-electrolyte battery includes the following features.
The positive-electrode active-material layer and the negative-electrode active-material layer each include a powder-molded body.
The positive-electrode active-material layer contains a positive-electrode active-material powder formed of boron-doped NCA and a sulfide-solid-electrolyte powder, or contains a positive-electrode active-material powder formed of NMC and a sulfide-solid-electrolyte powder.
The SE layer is a crystalline layer having a thickness of 2 μm or less.
The SE layer has a resistance of 50 Ω·cm² or less (more preferably 20 Ω·² or less).

A nonaqueous-electrolyte battery having the above-described configuration (8) according to the present invention is a nonaqueous-electrolyte battery produced by the production method (2) or (3). In this battery, the SE layer has a low resistance, compared with batteries produced by existing methods. Accordingly, the battery exhibits excellent battery characteristics (discharge capacity and discharge output), compared with existing batteries. In addition, the above-described nonaqueous-electrolyte battery according to the present invention includes the SE layer having a thickness that is probably the smallest to date. Accordingly, the nonaqueous-electrolyte battery has a very small thickness, compared with existing batteries. In addition, this nonaqueous-electrolyte battery according to the present invention also employs NCA (limited to boron-doped NCA) or NMC as the positive-electrode active material and hence has excellent cycle characteristics, compared with existing nonaqueous-electrolyte batteries.

(9) In a nonaqueous-electrolyte battery according to an embodiment of the present invention, the battery employing boron-doped NCA as the positive-electrode active material, a doping content of the boron is preferably 0.1 to 10 atomic % with respect to 100 atomic % of LiNi_{α}Co_{β}Al_{γ}O₂.

When the doping content of boron in NCA is in the above-described range, a nonaqueous-electrolyte battery having a high discharge capacity and excellent cycle characteristics can be provided.

### Advantageous Effects of Invention

In a method for producing a nonaqueous-electrolyte battery according to the present invention, in spite of bonding of a positive-electrode body and a negative-electrode body that are separately produced, the resultant nonaqueous-electrolyte battery according to the present invention does not have a high-resistance layer between the positive-electrode body and the negative-electrode body. Therefore, a nonaqueous-electrolyte battery according to the present invention exhibits excellent battery characteristics. In addition, by using NCA (limited to boron-doped NCA) or NMC as the positive-electrode active material, a nonaqueous-electrolyte battery having excellent cycle characteristics can be produced.

### BRIEF DESCRIPTION OF DRAWINGS

FIG. 1 is a longitudinal sectional view of a nonaqueous-electrolyte battery produced by laminating a positive-electrode body and a negative-electrode body.

FIG. 2 is a longitudinal sectional view of a positive-electrode body and a negative-electrode body to be laminated according to a first embodiment.

FIG. 3 is a schematic view illustrating an example of a Nyquist diagram obtained by an alternating current impedance method.

FIG. 4 is a longitudinal sectional view of a positive-electrode body and a negative-electrode body to be laminated according to a second embodiment.

FIG. 5 is a longitudinal sectional view of a positive-electrode body and a negative-electrode body to be laminated according to a third embodiment.

### DESCRIPTION OF EMBODIMENTS

### First Embodiment

### Overall Configuration of Nonaqueous-Electrolyte Battery

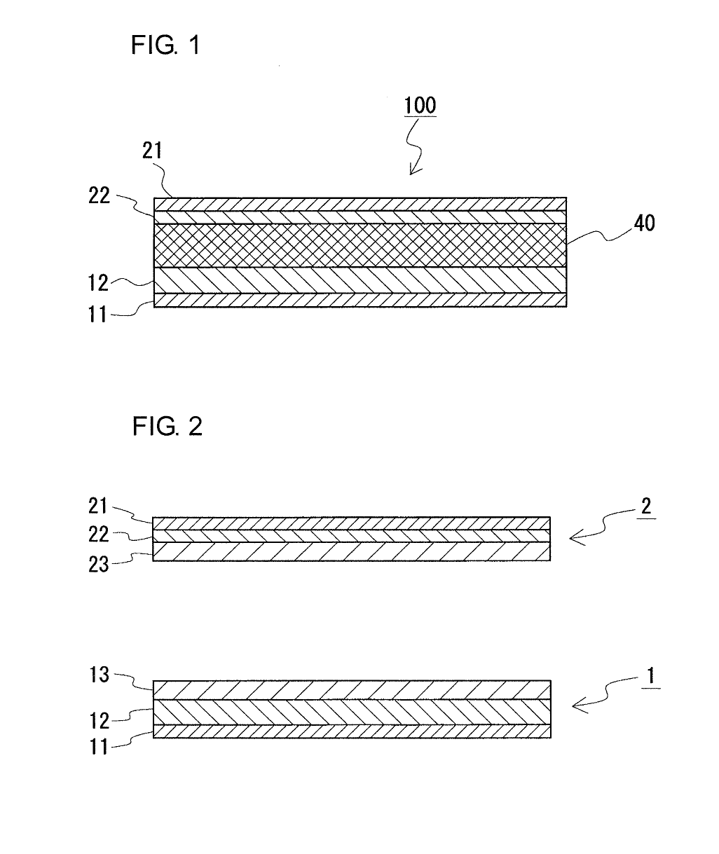

A nonaqueous-electrolyte battery 100 illustrated in FIG. 1 includes a positive-electrode collector 11, a positive-electrode active-material layer 12, a sulfide-solid-electrolyte layer (SE layer) 40, a negative-electrode active-material layer 22, and a negative-electrode collector 21. The nonaqueous-electrolyte battery 100 can be produced by a method for producing a nonaqueous-electrolyte battery including steps described below, that is, by laminating a positive-electrode body 1 and a negative-electrode body 2 that are separately produced as illustrated in FIG. 2.

### <Method for Producing Nonaqueous-Electrolyte Battery>

(α) The positive-electrode body 1 is produced.
(β) The negative-electrode body 2 is produced.
(γ) The positive-electrode body 1 and the negative-electrode body 2 are arranged so as to be in contact with each other and subjected to a heat treatment under application of a pressure to bond together the positive-electrode body 1 and the negative-electrode body 2.

Note that the order of the steps α and β can be inverted.

### <<Step α: Production of Positive-Electrode Body>>

The positive-electrode body 1 of the present embodiment has a configuration in which the positive-electrode active-material layer 12 and a positive-electrode-side solid-electrolyte layer (PSE layer) 13 are stacked on the positive-electrode collector 11. The positive-electrode body 1 may be produced by preparing a substrate that serves as the positive-electrode collector 11 and sequentially forming the other layers 12 and 13 on the substrate.

Alternatively, the positive-electrode collector 11 may be formed on a surface of the positive-electrode active-material layer 12, the surface being opposite to the PSE layer 13, after the step γ of bonding together the positive-electrode body 1 and the negative-electrode body 2.

### [Positive-Electrode Collector]

The substrate that serves as the positive-electrode collector 11 may be composed of a conductive material only or may be constituted by an insulating substrate having a conductive-material film thereon. In the latter case, the conductive-material film functions as a collector. The conductive material is preferably any one selected from Al, Ni, alloys of the foregoing, and stainless steel.

### [Positive-Electrode Active-Material Layer]

The positive-electrode active-material layer 12 is a powder-molded body obtained by press-molding a positive-electrode active-material powder and a sulfide-based solid-electrolyte (SE) powder. In addition, the positive-electrode active-material layer 12 may contain a conductive aid or a binder.

The positive-electrode active-material powder is a mass of positive-electrode active-material particles serving as a main material of the battery reaction. In the present invention, a positive-electrode active material used is LiNi_{α}Co_{β}Al_{γ}O₂ (α=0.80 to 0.81, β=0.15, γ=0.04 to 0.05, α+β+γ=1; hereafter NCA) or LiNi_{α}Mn_{β}Co_{γ}O₂ (α=0.1 to 0.8, β=0.1 to 0.8, γ=0.1 to 0.8, α+β=1; hereafter NMC). By using the NCA powder or the NMC powder as the positive-electrode active-material powder, the nonaqueous-electrolyte battery 100 having a high discharge capacity can be produced.

The NCA powder (particles) is doped with boron. By doping the NCA particles with boron, the cycle characteristics of the nonaqueous-electrolyte battery 100 can be enhanced. The reason for this is not known; however, boron added by doping to the NCA particles probably stabilizes the crystalline structure of NCA or bonding between NCA particles. Alternatively, boron may segregate on the surfaces of NCA particles and function as protective layers.

The doping content of boron in the NCA powder (particles) is preferably 0.1 to 10 atomic % with respect to 100 atomic % of NCA. When the doping content is in this range, the effect of doping the NCA powder with boron can be provided without decreasing the content ratio of the NCA powder in the positive-electrode active-material layer 12.

Doping of the NCA powder with boron can be performed by, for example, addition and firing of boron oxide (B₂O₃) during synthesis of NCA.

On the other hand, the NMC powder (particles) is not particularly doped with boron. Specific examples of NMC include LiNi_{0.5}Mn_{0.3}Co_{0.2}O₂ and LiNi_{1/3}Mn_{1/3}Co_{1/3}O₂.

The sulfide-based SE powder contained in the positive-electrode active-material layer 12 is preferably formed of, for example, Li₂S—P₂S₅ (if necessary, containing P₂O₅). When the positive-electrode active-material layer 12 is formed so as to contain a sulfide-based SE powder, the Li-ion conductivity of the positive-electrode active-material layer 12 can be improved so that the discharge capacity of the nonaqueous-electrolyte battery 100 can be increased. Although the sulfide-based SE powder may be amorphous or crystalline, crystalline powder having a high Li-ion conductivity is preferred.

The NCA particles (NMC particles) preferably have an average particle size of 4 to 8 μm. The sulfide-based SE particles preferably have an average particle size of 0.4 to 4 μm. The ratio of the average particle size of the NCA particles (NMC particles) to the average particle size of the sulfide-based SE particles is preferably 2:1 to 10:1. The average particle size of such particles can be determined in the following manner: a sectional image of the positive-electrode active-material layer 12 of the nonaqueous-electrolyte battery 100 is obtained; in this sectional image, the equivalent circle diameters of a plurality of particles (n=50 or more) are determined; and the equivalent circle diameters are averaged.

The mixing ratio (mass ratio) of the NCA powder (NMC powder) to the sulfide-based SE powder is preferably 5:5 to 8:2. When the above-described average particle sizes and the mixing ratio are satisfied, the positive-electrode active-material layer 12 can be formed such that voids are substantially not present and the distributions of the particles of the two types are highly balanced. Accordingly, the discharge capacity and cycle characteristics of the nonaqueous-electrolyte battery 100 can be enhanced. The mixing ratio can be obtained from the nonaqueous-electrolyte battery 100 in the following manner: in a section of the positive-electrode active-material layer 12 of the battery 100, the area ratio of the NCA powder (NMC powder) to the sulfide-based SE powder is calculated; and, on the basis of this area ratio, the atomic weight of NCA (NMC), the atomic weight of boron (not considered for NMC), and the atomic weight of sulfide SE, the mixing ratio can be calculated. Note that the mixing ratio can be regarded as being the same as the mixing ratio at the time of production of the nonaqueous-electrolyte battery 100.

Conditions for the press-molding can be appropriately selected. For example, the press-molding is preferably performed in an atmosphere at room temperature to 300° C. and at a surface pressure of 100 to 600 MPa. The positive-electrode active-material particles that are press-molded preferably have an average particle size of 1 to 20 μm. In addition, when electrolyte particles are used, the electrolyte particles preferably have an average particle size of 0.5 to 2 μm.

### [Positive-Electrode-Side Solid-Electrolyte Layer]

The positive-electrode-side solid-electrolyte layer (PSE layer) 13 is an amorphous Li-ion conductor containing a sulfide. The PSE layer 13 is crystallized by the step γ described below and serves as a portion of the SE layer 40 in the completed battery 100 illustrated in FIG. 1. Characteristics required for the PSE layer 13 are, after crystallization, a high Li-ion conductivity and a low electron conductivity. For example, after the PSE layer 13 in the amorphous state is crystallized, it preferably has a Li-ion conductivity (20° C.) of 10⁻⁵ S/cm or more, in particular, 10⁻⁴ S/cm or more. The PSE layer 13 having been crystallized preferably has an electron conductivity of 10⁻⁸ S/cm or less. The material of the PSE layer 13 may be, for example, Li₂S—P₂S₅. The PSE layer 13 may contain an oxide such as P₂O₅.

The PSE layer 13 may be formed by a vapor-phase process. Examples of the vapor-phase process include a vacuum deposition process, a sputtering process, an ion plating process, and a laser ablation process. In order to form the PSE layer 13 in the amorphous state, for example, the base member is cooled such that the temperature of the base member during film formation is equal to or lower than the crystallization temperature of the film. For example, when the PSE layer 13 is formed of Li₂S—P₂S₅, the temperature of the base member during film formation is preferably set to be 150° C. or less.

The PSE layer 13 formed by such a vapor-phase process preferably has a thickness of 0.1 to 5 μm.

When the vapor-phase process is employed, even in the case of the PSE layer 13 having such a small thickness, defects such as pin holes are scarcely generated in the PSE layer 13 and portions where the PSE layer 13 is not formed are scarcely left.

The PSE layer 13 preferably does not have a high C (carbon) content. This is because C may alter the solid electrolyte, resulting in a decrease in the Li-ion conductivity of the PSE layer 13. The PSE layer 13 becomes the SE layer 40 in a subsequent step. Accordingly, when the Li-ion conductivity of the PSE layer 13 decreases, the Li-ion conductivity of the SE layer 40 also decreases, resulting in degradation of the performance of the nonaqueous-electrolyte battery 100.

For this reason, the C content of the PSE layer 13 is preferably 10 atomic % or less, more preferably 5 atomic % or less, still more preferably 3 atomic % or less. Most preferably, the PSE layer 13 substantially does not contain C.

C contained in the PSE layer 13 is mainly derived from C contained as an impurity in a source material used for forming the PSE layer 13. For example, since lithium carbonate (Li₂CO₃) is used in the synthesis process of Li₂S—P₂S₅, which is a typical sulfide solid electrolyte, a source material having a low Li₂S—P₂S₅ purity may have a high C content. Thus, in order to suppress the C content of the PSE layer 13, the PSE layer 13 is preferably formed from a source material having a high Li₂S—P₂S₅ purity and a low C content. The source material having a high Li₂S—P₂S₅ purity may be, for example, a commercially available product adjusted to have a low C content.

In addition, C contained in the PSE layer 13 may be derived from a boat for holding a source material during the film formation of the PSE layer 13 by a vapor-phase process. The boat may be formed of C and C of the boat may enter the PSE layer 13 due to heat for evaporating the source material. However, by adjusting film-formation conditions such as the boat heating temperature and the atmosphere pressure during film formation, entry of C into the PSE layer 13 can be effectively suppressed.

### [Other Configurations]

When the PSE layer 13 contains a sulfide solid electrolyte, this sulfide solid electrolyte reacts with a positive-electrode active material that is an oxide and contained in the positive-electrode active-material layer 12 adjacent to the PSE layer 13. As a result, the resistance of the near-interface region between the positive-electrode active-material layer 12 and the PSE layer 13 may increase and the discharge capacity of the nonaqueous-electrolyte battery 100 may decrease. Thus, in order to suppress an increase in the resistance of the near-interface region, an intermediate layer may be formed between the positive-electrode active-material layer 12 and the PSE layer 13.

A material used for the intermediate layer may be an amorphous Li-ion-conductive oxide such as LiNbO₃, LiTaO₃, or Li₄Ti₅O₁₂. In particular, LiNbO₃ allows effective suppression of an increase in the resistance of the near-interface region between the positive-electrode active-material layer 12 and the PSE layer 13.

### <<Step β: Production of Negative-Electrode Body>>

The negative-electrode body 2 has a configuration in which the negative-electrode active-material layer 22 and a negative-electrode-side solid-electrolyte layer (NSE layer) 23 are stacked on the negative-electrode collector 21. The negative-electrode body 2 may be produced by preparing a substrate that serves as the negative-electrode collector 21 and sequentially forming the other layers 22 and 23 on the substrate. Alternatively, the negative-electrode collector 21 may be formed, after the step γ, on a surface of the negative-electrode active-material layer 22, the surface being opposite to the NSE layer 23.

### [Negative-Electrode Collector]

The substrate that serves as the negative-electrode collector 21 may be composed of a conductive material only or may be constituted by an insulating substrate having a conductive-material film thereon. In the latter case, the conductive-material film functions as a collector. For example, the conductive material is preferably any one selected from Al, Cu, Ni, Fe, Cr, and alloys of the foregoing (for example, stainless steel).

### [Negative-Electrode Active-Material Layer]

The negative-electrode active-material layer 22 is a powder-molded body obtained by press-molding a negative-electrode active-material powder and a sulfide-based SE powder. In addition, the negative-electrode active-material layer 22 may contain a conductive aid or a binder.

The negative-electrode active-material powder is a mass of negative-electrode active-material particles serving as a main material of the battery reaction. The negative-electrode active material may be C, Si, Ge, Sn, Al, a Li alloy, or a Li-containing oxide such as Li₄Ti₅O₁₂. Another negative-electrode active material usable is a compound represented by La₃M₂Sn₇ (M=Ni or Co).

The negative-electrode active-material layer 22 contains a sulfide-based SE powder that improves the Li-ion conductivity of the layer 22. The sulfide-based SE powder may be preferably composed of for example, Li₂S—P₂S₅. Although the sulfide-based SE powder may be amorphous or crystalline, a crystalline powder having a high Li-ion conductivity is preferred.

Conditions for the press-molding can be appropriately selected. For example, the press-molding is preferably performed in an atmosphere at room temperature to 300° C. and at a surface pressure of 100 to 600 MPa. The negative-electrode active-material particles that are press-molded preferably have an average particle size of 1 to 20 μm. In addition, when electrolyte particles are used, the electrolyte particles preferably have an average particle size of 0.5 to 2 μm.

### [Negative-Electrode-Side Solid-Electrolyte Layer]

As with the PSE layer 13 described above, the negative-electrode-side solid-electrolyte layer (NSE layer) 23 is an amorphous Li-ion conductor containing a sulfide. The NSE layer 23 also serves as a portion of the SE layer 40 of the battery 100 when the battery 100 is completed through the subsequent step γ. The NSE layer 23 having been crystallized is required to have a high Li-ion conductivity and a low electron conductivity. As in the PSE layer 13, the material of the NSE layer 23 is preferably Li₂S—P₂S₅ (if necessary, containing P₂O₅) or the like. In particular, this NSE layer 23 and the above-described PSE layer 13 are preferably the same in terms of composition, production process, and the like. This is because, when the NSE layer 23 and the PSE layer 13 are subjected to the subsequent step γ to constitute a monolayer, the SE layer 40, variations in the Li-ion conductivity in the thickness direction of the SE layer 40 are suppressed.

The NSE layer 23 formed by the above-described vapor-phase process preferably has a thickness of 0.1 to 5 μm.

When the vapor-phase process is employed, even in the case of the NSE layer 23 having such a small thickness, defects such as pin holes are scarcely generated in the NSE layer 23 and portions where the NSE layer 23 is not formed are scarcely left.

As with the PSE layer 13, the NSE layer 23 preferably does not have a high C (carbon) content. The reason for this, preferred values of the C content of the NSE layer 23, and the method for adjusting the C content of the NSE layer 23 are the same as in the PSE layer 13.

### <<Step γ: Bonding Together Positive-Electrode Body and Negative-Electrode Body>>

Subsequently, the positive-electrode body 1 and the negative-electrode body 2 are laminated such that the PSE layer 13 and the NSE layer 23 face each other to produce the nonaqueous-electrolyte battery 100. At this time, the PSE layer 13 and the NSE layer 23 being in contact with each other under a pressure are subjected to a heat treatment so that the PSE layer 13 and the NSE layer 23 in the amorphous state are crystallized. Thus, the PSE layer 13 and the NSE layer 23 are integrated.

The heat-treatment conditions in the step γ are selected so that the PSE layer 13 and the NSE layer 23 can be crystallized. When the heat-treatment temperature is excessively low, the PSE layer 13 and the NSE layer 23 are not sufficiently crystallized and a large number of unbonded interfacial portions remain between the PSE layer 13 and the NSE layer 23. Thus, the PSE layer 13 and the NSE layer 23 are not integrated. Conversely, when the heat-treatment temperature is excessively high, the PSE layer 13 and the NSE layer 23 are integrated, but a crystal phase having a low Li-ion conductivity may be formed. As with the heat-treatment temperature, a heat-treatment time that is excessively short may cause insufficient integration and a heat-treatment time that is excessively long may cause generation of a crystal phase having a low Li-ion conductivity. Although specific heat-treatment conditions vary in accordance with, for example, the composition of the PSE layer 13 and the NSE layer 23, in general, the heat-treatment conditions are preferably 130° C. to 300° C.×1 to 1200 minutes, more preferably 150° C. to 250° C.×30 to 150 minutes.

In the step γ, during the heat treatment, a pressure is applied in such directions that the PSE layer 13 and the NSE layer 23 are pressed onto each other. This is because the PSE layer 13 and the NSE layer 23 are kept in tight contact with each other during the heat treatment to thereby promote integration of the PSE layer 13 and the NSE layer 23. Even when the pressure applied is very low, the effect of promoting integration of the PSE layer 13 and the NSE layer 23 is provided. However, a high pressure facilitates promotion of the integration. Note that application of a high pressure may cause defects such as cracking in layers of the positive-electrode body 1 and the negative-electrode body 2. In particular, the positive-electrode active-material layer 12 and the negative-electrode active-material layer 22, which are powder-molded bodies, tend to crack. Thus, the pressure is preferably 160 MPa or less. Note that, since integration of the PSE layer 13 and the NSE layer 23 is actually achieved by a heat treatment, application of a pressure of 1 to 20 MPa will suffice.

By performing the step γ, the nonaqueous-electrolyte battery 100 including the SE layer 40, which is a crystallized monolayer, is formed. As described above, this monolayer, the SE layer 40 is formed by integration of the PSE layer 13 and the NSE layer 23. However, the interface between the PSE layer 13 and the NSE layer 23 scarcely remains. Accordingly, in the SE layer 40, a decrease in the Li-ion conductivity due to the interface does not occur. Thus, the SE layer 40 has a high Li-ion conductivity and a low electron conductivity. Note that the SE layer 40 tends to have marks formed by integration of the PSE layer 13 and the NSE layer 23, due to, for example, surface roughness of the PSE layer 13 and the NSE layer 23 to be integrated. In observation of the SE layer 40 in a longitudinal section of the nonaqueous-electrolyte battery 100, the marks are observed as cavities discontinuously arranged on an imaginary line extending in the width direction of the battery 100. The marks are preferably small. For example, the size of the marks can be evaluated on the basis of, in observation of a longitudinal section of the battery 100, the proportion of the total lengths of cavity portions with respect to the entire width length of the battery 100 (length in the left-right direction in FIG. 1). The proportion is preferably 5% or less, more preferably 3% or less, most preferably 1% or less. Needless to say, for example, the surface state of the PSE layer 13 and the NSE layer 23 to be integrated is preferably improved so that the PSE layer 13 and the NSE layer 23 are integrated to provide the SE layer 40 having no marks formed by bonding between the PSE layer 13 and the NSE layer 23.

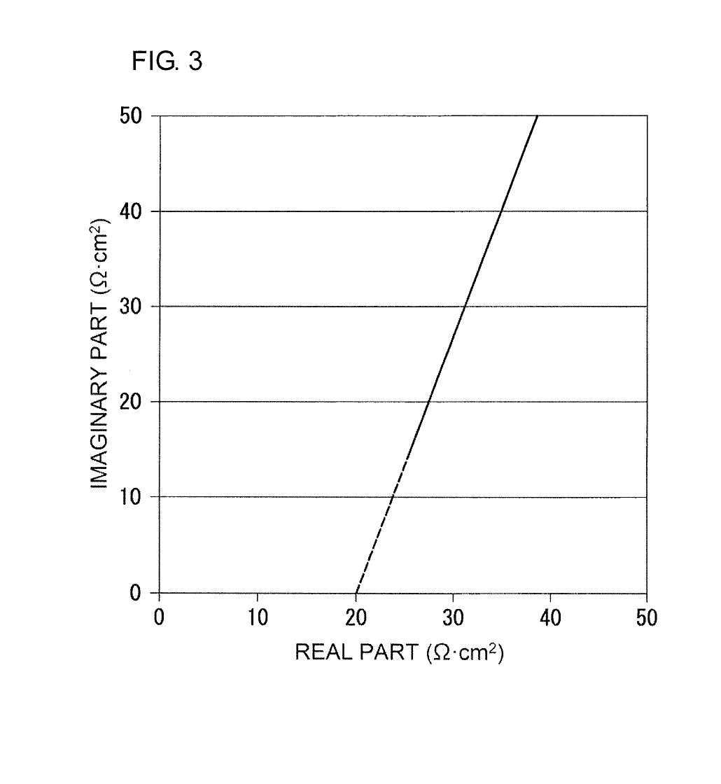

Regarding a characteristic of the SE layer 40 formed through the step γ, the resistance of the SE layer 40 is 50 Ω·cm² or less. The resistance is measured by the alternating current impedance method under the following measurement conditions: a voltage amplitude of 5 mV and a frequency in a range of 0.01 Hz to 10 kHz. In a Nyquist diagram (refer to FIG. 3) obtained by the alternating current impedance measurement, the intersection between the real axis and an extension (dotted line in the diagram) from a Nyquist plot (solid line in the diagram) corresponding to the highest frequency represents the resistance of the SE layer 40. This has been revealed by analysis of calculation results of an equivalent circuit and measurement results. In the case of the battery 100 providing the result in FIG. 3, the SE layer 40 has a resistance of 20 Ω·cm².

The SE layer 40 preferably does not have a high C content. The reason for this is that, as described in the description of the PSE layer 13, C may alter the solid electrolyte. The C content of the SE layer 40 can be regarded as the total of the C content of the PSE layer 13 and the C content of the NSE layer 23. Accordingly, the C content of the SE layer 40 is preferably 10 atomic % or less.

### <Advantages of Nonaqueous-Electrolyte Battery>

Compared with existing batteries obtained by press-bonding together the positive-electrode body 1 and the negative-electrode body 2 under a high pressure, the nonaqueous-electrolyte battery 100 obtained by the above-described production method exhibits excellent battery characteristics (discharge capacity and discharge output). This is because, in the SE layer 40, a high-resistance layer is not formed at the bonding interface between the PSE layer 13 and the NSE layer 23.

In addition, this nonaqueous-electrolyte battery 100 employs NCA (limited to boron-doped NCA) or NMC as the positive-electrode active material and hence has excellent cycle characteristics, compared with existing nonaqueous-electrolyte batteries.

### Second Embodiment

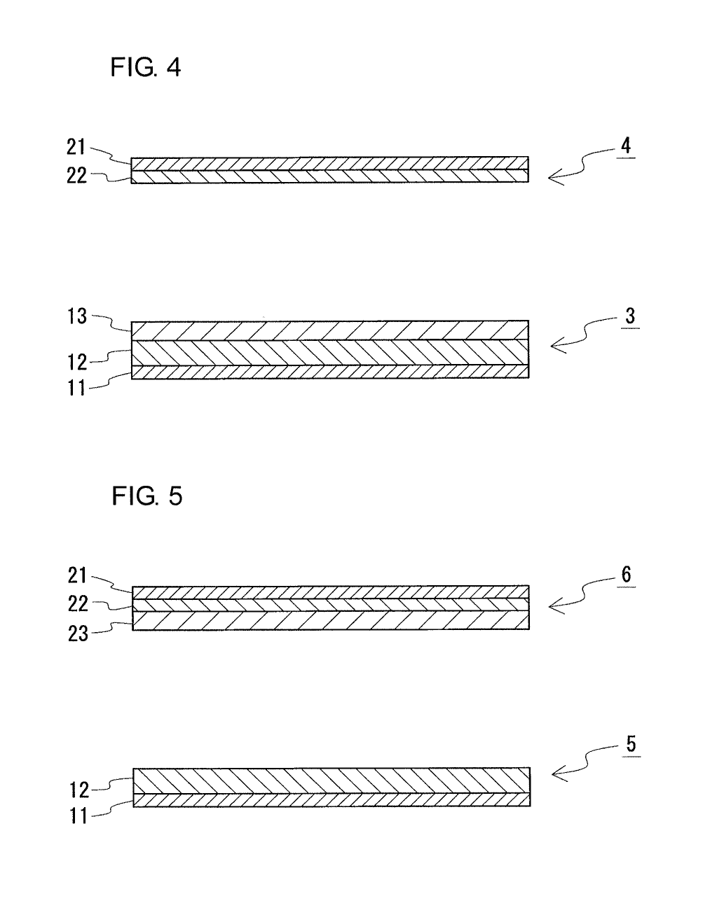

Alternatively, the nonaqueous-electrolyte battery 100 illustrated in FIG. 1 can be produced by a method for producing a nonaqueous-electrolyte battery including steps described below with reference to FIG. 4.

### <Method for Producing Nonaqueous-Electrolyte Battery>

(δ) A positive-electrode body 3 including a positive-electrode active-material layer 12 and a PSE layer 13 is produced.
(ε) A negative-electrode body 4 including a negative-electrode active-material layer 22 but not including a NSE layer is produced.
(ζ) The positive-electrode body 3 and the negative-electrode body 4 are arranged so as to be in contact with each other and subjected to a heat treatment under application of a pressure to bond together the positive-electrode body 3 and the negative-electrode body 4.

Note that the order of the steps δ and ε can be inverted.

The configurations of the layers of the positive-electrode body 3 and the negative-electrode body 4 and the conditions of the heat treatment under application of a pressure during bonding of the electrode bodies 3 and 4 are the same as in the first embodiment. Note that the PSE layer 13 needs to have a thickness of 2 μm or less. When the PSE layer 13 has a thickness of 2 μm or less, the solid electrolyte contained in the PSE layer 13 has high activity; when the positive-electrode body 3 and the negative-electrode body 4 are arranged so as to be in contact with each other and subjected to a heat treatment, the amorphous solid electrolyte in the PSE layer 13 tends to diffuse into the negative-electrode active-material layer 22. Accordingly, in the heat treatment, the amorphous solid electrolyte that is being crystallized in the PSE layer 13 is bonded to crystalline solid-electrolyte particles contained in the negative-electrode active-material layer 22. Thus, the positive-electrode body 3 and the negative-electrode body 4 are bonded together without substantial formation of a bonding interface between the positive-electrode body 3 and the negative-electrode body 4. Regarding the resultant SE layer 40 obtained through the step the resistance measured by the alternating current impedance method under the same conditions as in the first embodiment is also found to be 50 Ω·cm² or less. In contrast, when the PSE layer 13 has a thickness of more than 2 μm, the amorphous solid electrolyte contained in the PSE layer 13 has low activity and is less likely to diffuse into the negative-electrode active-material layer 22 by a heat treatment. Accordingly, a bonding interface having a high resistance tends to be formed between the positive-electrode body 3 and the negative-electrode body 4.

### Third Embodiment

Alternatively, the nonaqueous-electrolyte battery 100 illustrated in FIG. 1 can be produced by a method for producing a nonaqueous-electrolyte battery including steps described below with reference to FIG. 5.

### <Method for Producing Nonaqueous-Electrolyte Battery>

(η) A positive-electrode body 5 including a positive-electrode active-material layer 12 but not including a PSE layer is produced.
(θ) A negative-electrode body 6 including a negative-electrode active-material layer 22 and a NSE layer 23 is produced.
(τ) The positive-electrode body 5 and the negative-electrode body 6 are arranged so as to be in contact with each other and subjected to a heat treatment under application of a pressure to bond together the positive-electrode body 5 and the negative-electrode body 6.

Note that the order of the steps η and θ can be inverted.

The configurations of the layers of the positive-electrode body 5 and the negative-electrode body 6 and the conditions of the heat treatment under application of a pressure during bonding of the electrode bodies 5 and 6 are the same as in the first embodiment. Note that the NSE layer 23 needs to have a thickness of 2 μm or less so that, as in the second embodiment, the amorphous solid electrolyte contained in the NSE layer 23 has high activity. As a result, in the heat treatment, the amorphous solid electrolyte that is being crystallized in the NSE layer 23 is bonded to crystalline solid-electrolyte particles contained in the positive-electrode active-material layer 12. Thus, the positive-electrode body 5 and the negative-electrode body 6 are bonded together without substantial formation of a bonding interface between the positive-electrode body 5 and the negative-electrode body 6. Regarding the resultant SE layer 40 obtained through the step t, the resistance measured by the alternating current impedance method under the same conditions as in the first embodiment is also found to be 50 Ω·cm² or less.

### Test Example 1

The nonaqueous-electrolyte batteries 100 according to the first embodiment described with reference to FIG. 1 were actually produced. Each battery 100 was measured in terms of the capacity retention ratio, the resistance increase ratio, and the resistance of the SE layer 40 of the battery 100. In addition, a nonaqueous-electrolyte battery was produced for a comparative example and the battery was also measured in terms of the capacity retention ratio, the resistance increase ratio, and the resistance of the SE layer.

### <Nonaqueous-Electrolyte Battery in Example 1>

In order to produce the nonaqueous-electrolyte battery 100, the positive-electrode body 1 and the negative-electrode body 2 having the following configurations were prepared.

### [Positive-Electrode Body 1]

positive-electrode collector 11
   Al foil having a thickness of 10
positive-electrode active-material layer 12
   powder-molded body having a thickness of 200 μm and obtained by press-molding NCA powder and Li₂S—P₂S₅ powder
   NCA particles having an average particle size of 6
   NCA doped with 1 atomic % of boron
   Li₂S—P₂S₅ particles having an average particle size of 1 μm
   Li₂S—P₂S₅ particles obtained by a mechanical milling method and having a Li-ion conductivity of 1×10⁻³ S/cm
   NCA:Li₂S—P₂S₅=70:30 (mass ratio)
   press-molding conditions: in an atmosphere at 200° C. and at a surface pressure of 360 MPa
PSE layer 13
   amorphous Li₂S—P₂S₅ film having a thickness of 10 μm (vacuum deposition process)

### [Negative-Electrode Body 2]

negative-electrode collector 21
   stainless-steel foil having a thickness of 10 μm
negative-electrode active-material layer 22
   powder-molded body having a thickness of 200 μm and obtained by press-molding Li₄Ti₅O₁₂ (hereafter LTO) powder, Li₂S—P₂S₅ powder, and acetylene black (hereafter AB)
   LTO particles having an average particle size of 8 μm
   Li₂S—P₂S₅ particles having an average particle size of 1 μm
   Li₂S—P₂S₅ particles obtained by a mechanical milling method and having a Li-ion conductivity of 1×10⁻³ S/cm
   LTO:Li₂S—P₂S₅:AB=40:60:4 (mass ratio)
   press-molding conditions: in an atmosphere at 200° C. and at a surface pressure of 540 MPa
NSE layer 23
   amorphous Li₂S—P₂S₅ film having a thickness of 10 μm (vacuum deposition process)

Finally, in a dry atmosphere at a dew point of −40° C., the positive-electrode body 1 and the negative-electrode body 2 prepared were arranged such that the SE layers 13 and 23 thereof were in contact with each other and were subjected to a heat treatment while being pressed onto each other. Thus, a plurality of the nonaqueous-electrolyte batteries 100 were produced. The heat-treatment conditions were 200° C.×180 minutes and the pressure-application condition was 15 MPa.

### <Nonaqueous-Electrolyte Battery in Second Embodiment>

A nonaqueous-electrolyte battery 100 in Example 2 employed NMC (LiNi_{0.5}Mn_{0.3} CO_{0.2}O₂) as the positive-electrode active material and the other configurations (including the production method) were completely the same as those of the nonaqueous-electrolyte battery in Example 1.

### <Nonaqueous-Electrolyte Battery in Third Embodiment>

A nonaqueous-electrolyte battery 100 in Example 3 employed NMC (LiNi_{1/3}Mn_{1/3}Co_{1/3}O₂) as the positive-electrode active material and the other configurations (including the production method) were completely the same as those of the nonaqueous-electrolyte battery in Example 1.

### <Nonaqueous-Electrolyte Battery in Comparative Example>

A nonaqueous-electrolyte battery in Comparative example employed NCA not doped with boron as the positive-electrode active material and the other configurations (including the production method) were completely the same as those of the nonaqueous-electrolyte battery 100 in Example 1.

### <Test Conditions and Test Results>

Regarding the thus-produced nonaqueous-electrolyte batteries in Examples 1 to 3 and Comparative example, the resistance of the SE layer of each battery was measured by the alternating current impedance method described with reference to FIG. 3. As a result, the resistance of the SE layer of each battery was 17 Ω·². In addition, a portion probably corresponding to the boundary between the PSE layer and the NSE layer in a longitudinal section of each battery was observed with a scanning electron microscope. As a result, in each battery, cavities that were marks formed by bonding of the PSE layer and the NSE layer were observed. In each battery, the proportion of the total lengths of cavity portions with respect to the entire width length of the battery was 1%.

In addition, each of the nonaqueous-electrolyte batteries in Examples 1 to 3 and Comparative example was contained in a coin cell and subjected to a constant-current charge-discharge test under conditions described below to measure the capacity retention ratio and the resistance increase ratio of the battery. The results are described in Table I. Note that the capacity retention ratio (the resistance increase ratio) is a ratio of the discharge capacity (resistance) of a battery at the 500th cycle to the discharge capacity (resistance) of the battery at the 1st cycle.
cutoff voltage: 3.5 to 1.0 V
current density: 3 mA/cm²
test temperature: 60° C. (for the purpose of acceleration)
number of cycles: 500 cycles

TABLE I

| | Capacity | Resistance |
|---|---|---|
| | retention | increase |
| Battery | ratio (%) | ratio (%) |
| Example 1 | 99 | 334 |
| Example 2 | 99 | 142 |
| Example 3 | 100 | 121 |
| Comparative example | 71 | 778 |

Table I indicates that the capacity retention ratio and the resistance increase ratio of the nonaqueous-electrolyte battery in Example 1 were good, compared with the nonaqueous-electrolyte battery in Comparative example. These batteries are different from each other only in terms of whether NCA, which serves as the positive-electrode active material, is doped with boron or not. Accordingly, it has been demonstrated that doping of NCA with boron improves the capacity retention ratio and the resistance increase ratio of a nonaqueous-electrolyte battery.

In addition, Table I indicates that the capacity retention ratios and the resistance increase ratios of the nonaqueous-electrolyte batteries in Examples 2 and 3 employing NMC as the positive-electrode active material were good, compared with the nonaqueous-electrolyte battery in Example 1. This is probably because the NMC used in the battery in Example 2 is less likely to undergo a change in volume due to charge and discharge of the battery.

Note that the present invention is not limited by the above-described embodiments at all. That is, the configurations of the nonaqueous-electrolyte batteries described in the above-described embodiments can be appropriately modified without departing from the spirit and scope of the present invention.

### INDUSTRIAL APPLICABILITY

A method for producing a nonaqueous-electrolyte battery according to the present invention is suitable for the production of a nonaqueous-electrolyte battery used as a power supply of an electric device that is intended to be repeatedly charged and discharged.

### REFERENCE SIGNS LIST

100 nonaqueous-electrolyte battery
1, 3, 5 positive-electrode body
11 positive-electrode collector
12 positive-electrode active-material layer
13 positive-electrode-side solid-electrolyte layer (PSE layer)
2, 4, 6 negative-electrode body
21 negative-electrode collector
22 negative-electrode active-material layer
23 negative-electrode-side solid-electrolyte layer (NSE layer)
40 sulfide-solid-electrolyte layer (SE layer)

1. A method for producing a nonaqueous-electrolyte battery including a positive-electrode active-material layer, a negative-electrode active-material layer, and a sulfide-solid-electrolyte layer disposed between these active-material layers, the method comprising:
a step of preparing a positive-electrode body including a positive-electrode active-material layer including a powder-molded body, and a positive-electrode-side solid-electrolyte layer that is amorphous and formed on the positive-electrode active-material layer by a vapor-phase process;
a step of preparing a negative-electrode body including a negative-electrode active-material layer including a powder-molded body, and a negative-electrode-side solid-electrolyte layer that is amorphous and formed on the negative-electrode active-material layer by a vapor-phase process; and
a step of bonding together the positive-electrode body and the negative-electrode body by subjecting the electrode bodies being arranged such that the solid-electrolyte layers of the electrode bodies are in contact with each other, to a heat treatment under application of a pressure to crystallize the positive-electrode-side solid-electrolyte layer and the negative-electrode-side solid-electrolyte layer,
wherein the positive-electrode active-material layer is
obtained by press-molding a positive-electrode active-material powder formed of boron-doped LiNi_{α}Co_{β}Al_{γ}O₂ (α=0.80 to 0.81, β=0.15, γ=0.04 to 0.05) and a sulfide-solid-electrolyte powder, or
obtained by press-molding a positive-electrode active-material powder formed of LiNi_{α}Mn_{β}Co_{γ}O₂ (α=0.1 to 0.8, β=0.1 to 0.8, γ=0.1 to 0.8) and a sulfide-solid-electrolyte powder.

2. A method for producing a nonaqueous-electrolyte battery including a positive-electrode active-material layer, a negative-electrode active-material layer, and a sulfide-solid-electrolyte layer disposed between these active-material layers, the method comprising:
a step of preparing a positive-electrode body including a positive-electrode active-material layer including a powder-molded body, and a positive-electrode-side solid-electrolyte layer that is amorphous, has a thickness of 2 μM or less, and is formed on the positive-electrode active-material layer by a vapor-phase process;
a step of preparing a negative-electrode body including a negative-electrode active-material layer including a powder-molded body; and
a step of bonding together the positive-electrode body and the negative-electrode body by subjecting the electrode bodies being arranged such that the positive-electrode-side solid-electrolyte layer and the negative-electrode active-material layer are in contact with each other, to a heat treatment under application of a pressure to crystallize the positive-electrode-side solid-electrolyte layer,
wherein the positive-electrode active-material layer is
obtained by press-molding a positive-electrode active-material powder formed of boron-doped LiNi_{α}Co_{β}Al_{γ}O₂ (α=0.80 to 0.81, β=0.15, γ=0.04 to 0.05) and a sulfide-solid-electrolyte powder, or
obtained by press-molding a positive-electrode active-material powder formed of LiNi_{α}Mn_{β}Co_{γ}O₂ (α=0.1 to 0.8, β=0.1 to 0.8, γ=0.1 to 0.8) and a sulfide-solid-electrolyte powder.

3. A method for producing a nonaqueous-electrolyte battery including a positive-electrode active-material layer, a negative-electrode active-material layer, and a sulfide-solid-electrolyte layer disposed between these active-material layers, the method comprising:
a step of preparing a positive-electrode body including a positive-electrode active-material layer including a powder-molded body;
a step of preparing a negative-electrode body including a negative-electrode active-material layer including a powder-molded body, and a negative-electrode-side solid-electrolyte layer that is amorphous, has a thickness of 2 μm or less, and is formed on the negative-electrode active-material layer by a vapor-phase process; and
a step of bonding together the positive-electrode body and the negative-electrode body by subjecting the electrode bodies being arranged such that the positive-electrode active-material layer and the negative-electrode-side solid-electrolyte layer are in contact with each other, to a heat treatment under application of a pressure to crystallize the negative-electrode-side solid-electrolyte layer,
wherein the positive-electrode active-material layer is
obtained by press-molding a positive-electrode active-material powder formed of boron-doped LiNi_{α}Co_{β}Al_{γ}O₂ (α=0.80 to 0.81, β=0.15, γ=0.04 to 0.05) and a sulfide-solid-electrolyte powder, or
obtained by press-molding a positive-electrode active-material powder formed of LiNi_{α}Mn_{β}Co_{γ}O₂ (α=0.1 to 0.8, β=0.1 to 0.8, γ=0.1 to 0.8) and a sulfide-solid-electrolyte powder.

4. The method for producing a nonaqueous-electrolyte battery according to claim 1, wherein a doping content of the boron is 0.1 to 10 atomic % with respect to 100 atomic % of LiNi_{α}Co_{β}Al_{γ}O₂.

5. The method for producing a nonaqueous-electrolyte battery according to claim 1, wherein the heat treatment is performed at 130° C. to 300° C. for 1 to 1200 minutes.

6. The method for producing a nonaqueous-electrolyte battery according to claim 5, wherein the pressure applied is 160 MPa or less.

7. A nonaqueous-electrolyte battery comprising a positive-electrode active-material layer, a negative-electrode active-material layer, and a sulfide-solid-electrolyte layer disposed between these active-material layers,
wherein the positive-electrode active-material layer and the negative-electrode active-material layer each include a powder-molded body,
the solid-electrolyte layer is a crystalline integrated layer formed by bonding together a positive-electrode-side solid-electrolyte layer disposed on a side of the positive-electrode active-material layer and a negative-electrode-side solid-electrolyte layer disposed on a side of the negative-electrode active-material layer,
the positive-electrode active-material layer contains a positive-electrode active-material powder formed of boron-doped LiNi_{α}Co_{β}Al_{γ}O₂ (α=0.80 to 0.81, β=0.15, γ=0.04 to 0.05) and a sulfide-solid-electrolyte powder, or contains a positive-electrode active-material powder formed of LiNi_{α}Mn_{β}Co_{γ}O₂ (α=0.1 to 0.8, β=0.1 to 0.8, γ=0.1 to 0.8) and a sulfide-solid-electrolyte powder, and
the solid-electrolyte layer has a resistance of 50 Ω·cm² or less.

8. A nonaqueous-electrolyte battery comprising a positive-electrode active-material layer, a negative-electrode active-material layer, and a sulfide-solid-electrolyte layer disposed between these active-material layers,
wherein the positive-electrode active-material layer and the negative-electrode active-material layer each include a powder-molded body,
the positive-electrode active-material layer contains a positive-electrode active-material powder formed of boron-doped LiNi_{α}Co_{β}Al_{γ}O₂ (α=0.80 to 0.81, β=0.15, γ=0.04 to 0.05) and a sulfide-solid-electrolyte powder, or contains a positive-electrode active-material powder formed of LiNi_{α}Mn_{β}Co_{γ}O₂ (α=0.1 to 0.8, β=0.1 to 0.8, γ=0.1 to 0.8) and a sulfide-solid-electrolyte powder,
the solid-electrolyte layer is a crystalline layer having a thickness of 2 μm or less, and
the solid-electrolyte layer has a resistance of 50 Ω·cm² or less.

9. The nonaqueous-electrolyte battery according to claim 7, wherein a doping content of the boron is 0.1 to 10 atomic % with respect to 100 atomic % of LiNi_{α}Co_{β}Al_{γ}O₂.

10. The method for producing a nonaqueous-electrolyte battery according to claim 2, wherein a doping content of the boron is 0.1 to 10 atomic % with respect to 100 atomic % of LiNi_{α}Co_{β}Al_{γ}O₂.

11. The method for producing a nonaqueous-electrolyte battery according to claim 2, wherein the heat treatment is performed at 130° C. to 300° C. for 1 to 1200 minutes.

12. The method for producing a nonaqueous-electrolyte battery according to claim 11, wherein the pressure applied is 160 MPa or less.

13. The method for producing a nonaqueous-electrolyte battery according to claim 3, wherein a doping content of the boron is 0.1 to 10 atomic % with respect to 100 atomic % of LiNi_{α}Co_{β}Al_{γ}O₂.

14. The method for producing a nonaqueous-electrolyte battery according to claim 3, wherein the heat treatment is performed at 130° C. to 300° C. for 1 to 1200 minutes.

15. The method for producing a nonaqueous-electrolyte battery according to claim 14, wherein the pressure applied is 160 MPa or less.

16. The nonaqueous-electrolyte battery according to claim 8, wherein a doping content of the boron is 0.1 to 10 atomic % with respect to 100 atomic % of LiNi_{α}Co_{β}Al_{γ}O₂.
